(19) United States
(12) Patent Application Publication
(10) Pub. No.: US 2013/0160602 A1
(43) Pub. Date: Jun. 27, 2013

(54) MECHANICAL SYSTEM, INJECTION PUMP COMPRISING SUCH A MECHANICAL SYSTEM AND METHOD FOR MANUFACTURING SUCH A MECHANICAL SYSTEM

(71) Applicant: Aktiebolaget SKF, Goteborg (SE)

(72) Inventor: Charles Chambonneau, Joue Les Tours (FR)

(73) Assignee: AKTIEBOLAGET SKF, Goteborg (SE)

(21) Appl. No.: 13/709,113

(22) Filed: Dec. 10, 2012

(30) Foreign Application Priority Data
Dec. 23, 2011 (EP) 11306763.1

(51) Int. Cl. F16H 25/08; F16C 43/02

(52) U.S. Cl. CPC F16H 25/08; F16C 43/02
USPC 74/569; 29/898.042

(57) ABSTRACT

The invention relates to a mechanical system, comprising a support element which includes two bores extending along a first axis (X1), a pin which is fitted in the two bores and includes two opposite ends, each adapted to be caulked in one of the two bores, and a roller element which is positioned between the two bores along the first axis (X1) and is movable in rotation relative to the pin around the first axis (X1). At least one bore has at least one radial recess which extends from the bore along a radial direction (D1) relative to the first axis (X1) and is adapted to receive a plastically deformed radial portion of the caulked end of the pin. The invention also relates to an injection pump comprising such a mechanical system and a method for manufacturing such a mechanical system.

### TECHNICAL FIELD OF THE INVENTION

The invention concerns a mechanical system. The invention also concerns an injection pump for a motor vehicle, preferably for a diesel truck engine, comprising such a mechanical system. The invention also concerns a method for manufacturing such a mechanical system.

### BACKGROUND OF THE INVENTION

Today, a cam follower for diesel truck engines comprises a tappet, a roller and a pin in bronze or steel. The tappet is formed with two lateral flanges, delimiting an intermediate gap between them and each comprising a cylindrical bore, possibly beveled. The roller is positioned in intermediate gap, between both flanges and bores. The pin is fitted in the two bores, such that the roller is movable in rotation relative to the pin around its axis. The pin is then caulked, in other words plastically deformed, on both opposite ends to create a mechanical connection by press-fit in the tappet bores.

In heavy duty applications, such as in diesel truck engines, the mechanical interface between pin and tappet bores withstands micro-movements, generating wear on this interface, reducing press-fit and finally allowing pin rotation or axial movement. The pin axial movement leads to an important wear of tappet bores and should be especially prevented. Pin rotation produces a slower wear but eventually finishes with an axial pin movement.

A caulking method for manufacturing a cam follower is known from EP-A-1 484 517. A pin is positioned in bores of a roller support. Pin opposite ends are caulked in respective bores. More precisely, a bevelled portion of each roller support bore receives a caulked fixing portion of the pin. When the mechanical interface between pin and bores withstands micro-movements, the beveled portions cannot prevent pin rotation, eventually leading to pin axial movement.

It is also known to increase the caulking load during caulking assembly step, in order to reinforce the mechanical connection between pin and bores at their interface. However, this solution creates additional stress or out-of-roundness problem within the mechanical system, possibly damaging the interface between pin and tappet.

### SUMMARY OF THE INVENTION

The aim of the invention is to provide an improved mechanical system, with a high lifetime, in particular in heavy duty applications such as diesel truck engines.

To this end, the invention concerns a mechanical system, comprising a support element which includes two bores extending along a first axis, a pin which is fitted in the two bores and comprises two opposite ends, each adapted to be caulked in one of the two bores, and a roller element which is positioned between the two bores along the first axis and is movable in rotation relative to the pin around the first axis. This mechanical system is characterized in that at least one bore comprises at least one radial recess which extends from the bore along a radial direction relative to the first axis and is adapted to receive a plastically deformed radial portion of the caulked end of the pin.

Thanks to the invention, the mechanical connection between pin and support element bores, such as tappet bores, is reinforced by the pin material compressed in the radial recesses during the caulking step. Both unwanted rotation and axial movement of the pin are prevented, thus improving the lifetime of the mechanical system.

According to further aspects of the invention which are advantageous but not compulsory, such a mechanical system may incorporate one or several of the following features:
Each bore comprises at least one radial recess.
The radial recess or recesses are located towards the thickest portion of the support element.
At least one radial recess extends along the first axis through the full length of its bore.
At least one radial recess is delimited in the bore near an outer side, which is opposed to the roller element along the first axis, of its bore.
At least one radial recess has a triangular or rounded concave shape in a transversal plane comprising the first axis.
At least one of the two bores comprises several radial recesses.
The radial recesses are regularly distributed around the first axis of the bore.
The pin is made of steel, preferably with both pin ends being subjected to heat treatment before being caulked.
The pin is made of bronze.
The mechanical system comprises a sliding or rolling bearing with bearing elements positioned between the pin and the roller element.
The mechanical system constitutes a cam follower, wherein the support element is a tappet movable along a translation axis perpendicular to the first axis and wherein the roller element is adapted to roll on an outer surface of a cam.
The mechanical system constitutes a rocker arm, wherein the roller element is secured to an arm and a tappet, possibly acting on a valve stem.

The invention also concerns an injection pump for a motor vehicle, preferably for a diesel truck engine, equipped with a mechanical system as mentioned here-above.

The invention also concerns a method for manufacturing a mechanical system, comprising a support element, a pin and a roller element, the method including the following steps:
a) the support element is formed with two flanges delimiting an intermediate gap;
b) two bores extending along a first axis are bored in the two flanges of the support element;
d) the roller element is positioned in the intermediate gap of the support element, between the two flanges and the two bores;
e) the pin comprising two opposite ends is fitted in the two bores, the roller element being movable in rotation relative to the pin around the first axis;
f) the two opposite ends of the pin are simultaneously caulked in the two bores.

The method is characterized in that it also comprises a step c), wherein at least one radial recess is formed in at least one bore, said radial recess extending from the bore along a radial direction relative to the first axis, step c) being implemented after step a) and before step e), preferably between step b) and step d), and in that in step f), a radial portion of the caulked ends of the pin is plastically deformed and received in the or each radial recess delimited in the or each bore.

This method is adapted to manufacture a mechanical system as mentioned hereabove.

### BRIEF DESCRIPTION OF THE DRAWINGS

The invention will now be explained in correspondence with the annexed figures, as an illustrative example, without restricting the object of the invention. In the annexed figures:

FIG. 1 is a perspective view of a mechanical system according to the invention, of the cam follower type, comprising a tappet, a pin and a roller, in a configuration preceding a caulking step;

FIG. 2 is a sectional view along plane II of FIG. 1;

FIG. 3 is a sectional view along plane III of FIG. 1;

FIG. 4 is a partial side view along arrow IV of FIG. 1, where the pin, the roller and a portion of the tappet are not shown;

FIG. 5 is a sectional view along line V-V of FIG. 4;

FIGS. 6 and 7 are views similar to FIGS. 4 and 5 respectively, in a configuration following a caulking step, where both ends of the pin are caulked in tappet bores;

FIG. 8 is a sectional view, at a larger scale, of detail VIII in FIG. 7;

FIGS. 9 and 10 are partial views, similar to FIGS. 4 and 5 respectively, of a cam follower according to a second embodiment of the invention;

FIG. 11 is a partial view similar to FIG. 4 of a cam follower according to a third embodiment of the invention;

FIG. 12 is a partial view similar to FIG. 4 of a cam follower according to a fourth embodiment of the invention; and

FIGS. 13 to 16 are partial views, similar to FIGS. 4 to 7 respectively, of a cam follower according to a fifth embodiment of the invention.

### DETAILED DESCRIPTION OF THE INVENTION

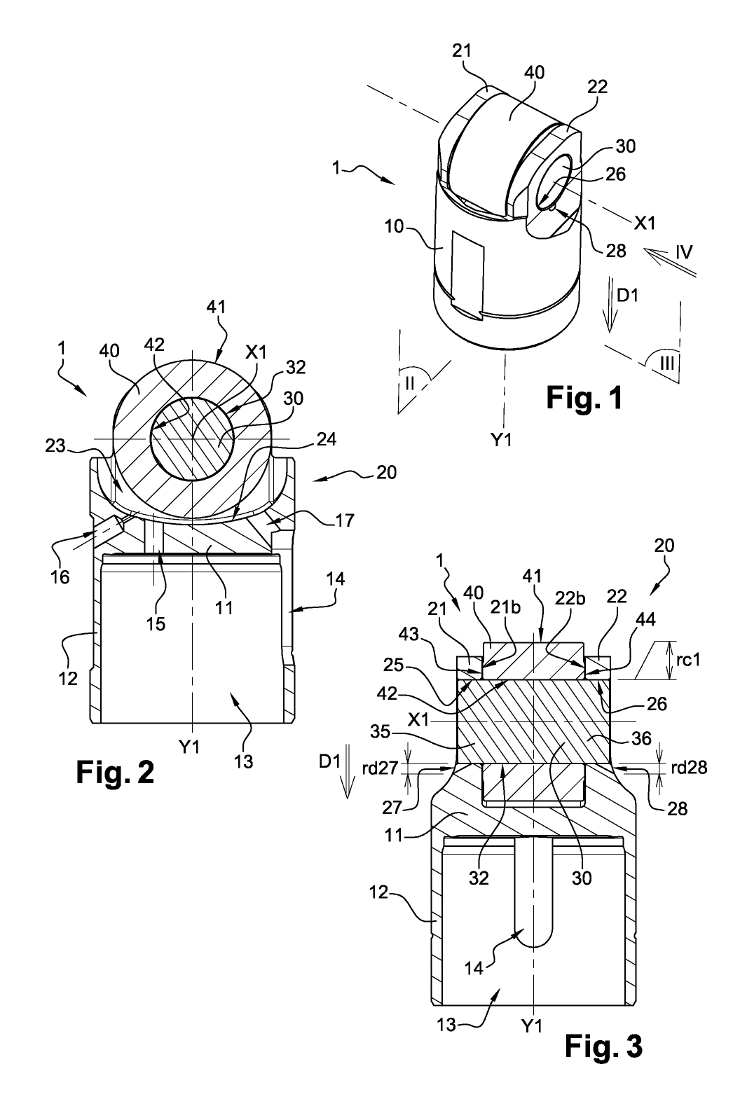

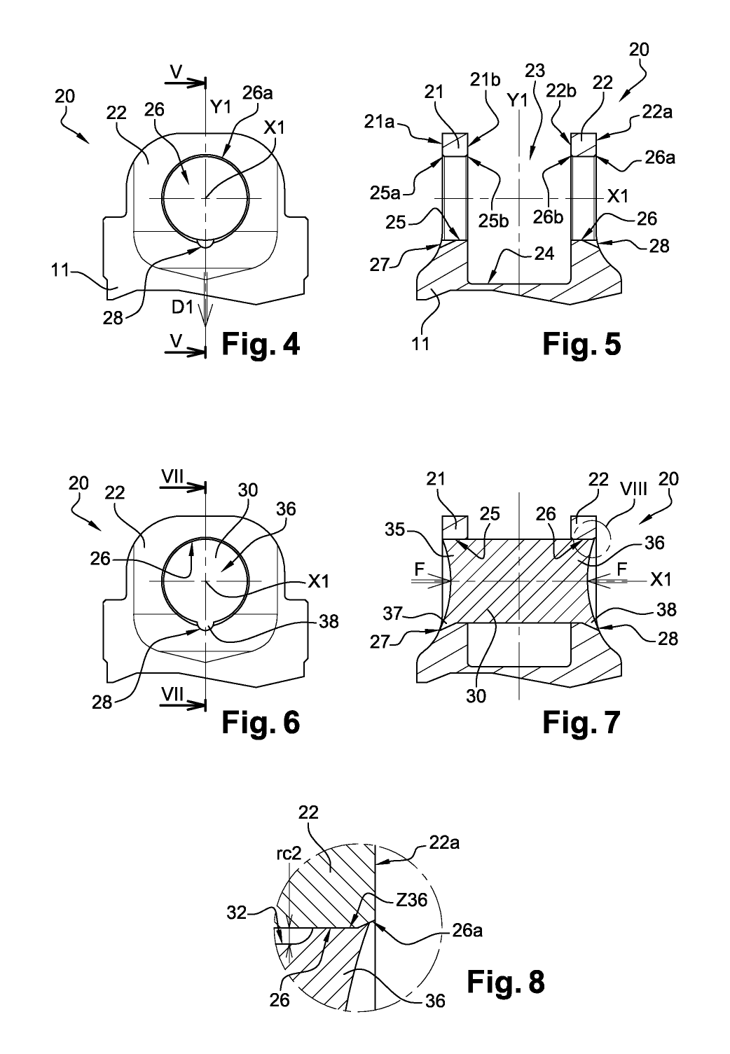

The mechanical system 1 represented on FIGS. 1 to 8 is of the cam follower type, adapted to equip an injection pump for a motor vehicle, preferably for a diesel truck engine, not shown.

The system 1 comprises a tappet 10, a pin 30 and a roller 40, together forming a plain bearing. Indeed, in heavy duty applications such as in diesel truck engines, there is a lack of space for the implementation of a rolling bearing, thus justifying the use of a plain bearing.

As shown on FIGS. 2 and 3, the tappet 10 comprises a central portion 11 interposed between a cylindrical portion 12 and a bearing portion 20. The cylindrical portion 12 is centered on a longitudinal axis Y1 and delimits a cavity 13 inside tappet 10. This cavity 13 is adapted to receive a shaft, not shown, for moving tappet 10 along axis Y1. Tappet 10 forms a support element for pin 30 and roller 40. Specifically, the bearing portion 20 is adapted to receive pin 30 and roller 40. To this end, bearing portion 20 comprises two lateral flanges 21 and 22 extending from central portion 11 parallel to axis Y1 in a bifurcated manner, on both side of axis Y1. The flanges 21 and 22 delimits an intermediate gap 23 between them, with a concave bottom 24 formed on the central portion 11. The tappet 10 also comprises several holes and bores 14, 15, 16 and 17, provided for lubrication or other functions that are not subjects of the present invention. Due to the positions of holes 13, 14, 15, 16, 17 and 23, central portion 11 is the thickest and most resistant portion of tappet 10.

On the bearing portion 20, each lateral flange 21 and 22 includes a cylindrical bore, respectively 25 and 26. Both bores 25 and 26 have the same diameter and extends through flanges 21 and 22 along a same axis X1, which is perpendicular to axis Y1. As shown particularly on FIG. 5, flange 21 has an outer side 21a opposite to gap 23 and an inner plane side 21b facing gap 23. Bore 25 has an outer chamfer 25a formed on outer side 21a and an inner chamfer 25b formed on inner side 21b, around axis X1. Similarly, flange 22 has an outer side 22a opposite gap to 23 and an inner plane side 22b facing gap 23. Bore 26 has an outer chamfer 26a formed on outer side 22a and an inner chamfer 26b formed on inner side 22b, around axis X1. Chamfers 25a, 25b, 26a and 26b facilitate the insertion of pin 30 in bores 25 and 26.

Roller element 40 is positioned in mechanical system 1 before pin 30. More precisely, roller 40 is positioned in the intermediate gap 23, between the two flanges 21 and 22 and the two bores 25 and 26 along axis X1. Roller 40 has an outer cylindrical surface 41 and an inner cylindrical bore 42, which extend between two lateral sides 43 and 44.

Pin 30 comprises a cylindrical surface 32 extending between two pin ends 35 and 36. When pin 30 is inserted in bores 25 and 26 of tappet 10, surface 32 is adjusted with bore 42 of roller 40, such that roller 40 is movable in rotation relative to pin 30 around axis X1. Both pin and roller axis merge with axis X1. Roller 40 is then adapted to roll, more precisely its surface 41 can roll, on an outer surface of a non represented cam.

A radial clearance rc1 may be present between the surface 32 of pin 30 and the inner surface of each bore 25 and 26, radially to axis X1. Existence and value of clearance rc1 depends on manufacturing tolerances of pin 30, as bores 25 and 26. Preferably, clearance rc1 is as small as possible before the caulking step and is further reduced by this caulking step.

In practice, pin ends 35 and 36 are adapted to be caulked by press-fit, respectively in bores 25 and 26. Pin 30 is made of metal, such as steel or bronze. If made of steel, pin 30 is preferably subjected to heat treatment before the caulking step. More precisely, pin ends 35 and 36 may be subjected to an electromagnetic induction heating step just before the caulking step.

FIG. 7 shows opposed forces F applied simultaneously to both pin ends 35 and 36 during the caulking step, from outer sides 21a and 22a respectively. As shown on FIGS. 6 to 8, the material of both ends 35 and 36 is plastically deformed under action of these forces F, exerted by a press or any other suitable means. The deformation is substantially exaggerated on the figures to better show the caulking step result.

As shown on FIG. 8, a zone Z36 of pin end 36 is radially compressed against bore 26 near outer side 22a, while at the same time chamfer 26a can receive a portion of caulked end 36, depending on the total length of the pin 30 along the axis X1. Only deformed caulked end 36 is shown on FIG. 8, whereas caulked 35 is similarly deformed. However, even if zone Z36 of end 36 is radially compressed against bore 36, a radial clearance rc2 between pin surface 32 and bore 26 may possibly remain further away from side 22a than zone Z36. Furthermore, even if chamfer 26a receives a portion of end 36, the rotation of pin 30 is not prevented. Under those conditions, the mechanical interface between tappet 10 and pin 30 could be insufficiently resistant to micro-movements and wear in heavy duty applications.

In order to solve the aforementioned problems affecting systems of the prior art, and according to the invention, each bore 25 and 26 is provided with a radial recess, respectively 27 and 28, which extends from the bore 25 or 26 along a radial direction D1 relative to the axis X1. These recesses 27-28 can be formed by any suitable means, including with a drill or by plastic deformation. During the above mentioned caulking step, the flow of plastically deformed material of pin 30 goes into these recesses 27-28, as shown on FIGS. 6 and 7. In other words, each radial recess 27 and 28 is adapted to receive a plastically deformed radial portion, respectively 37 or 38, of the caulked ends 35 and 36 of the pin 30.

Within the meaning of the invention, a radial recess 27 or 28 is a groove, a slot or a channel which extends beyond the inner surface of a bore, respectively 25 or 26, essentially along radial direction D1 and to some extent along an axial direction parallel to axis X1, only on a portion of the perimeter of the bore 25 or 26. This definition specifically excludes bevels or chamfers, which are formed throughout the entire perimeter of the bore and are not radial recesses.

On the example of FIGS. 1 to 7, each recess 27-28 has a triangular shape in a transversal plane comprising both axes X1 and Y1. This transversal plane is a symmetry plane for recesses 27-28 and bores 25-26. Each recess 27-28 is delimited in bore 25-26 near its outer side, which is opposed to roller 40 along axis X1. In other words, each recess 27-28 connects its bore 25-26 and the outer side 21a-22a of flange 21-22.

Preferably, recesses 27-28 are located in flanges 21-22 and bores 25-26 towards the thickest portion 11 of tappet 10, so as to preserve the mechanical resistance of flanges 21 and 22. Also preferably, each recess 27 and 28 has a maximum radial depth, respectively rd27 or rd28, measured radially with respect to axis X1, specifically adapted to accommodate a sufficient amount of the material of pin 30.

Thus, the invention succeeds in providing an efficient and resistant mechanical connection between tappet 10 and pin 30, improved in comparison with the prior art. Extra material flows of portions 37-38 into recesses 27-28 reinforce this connection and prevent pin rotation around axis X1. At the same time, as portions 37-38 conform the inner shape of recesses 27-28, pin movement along axis X1 is also efficiently prevented.

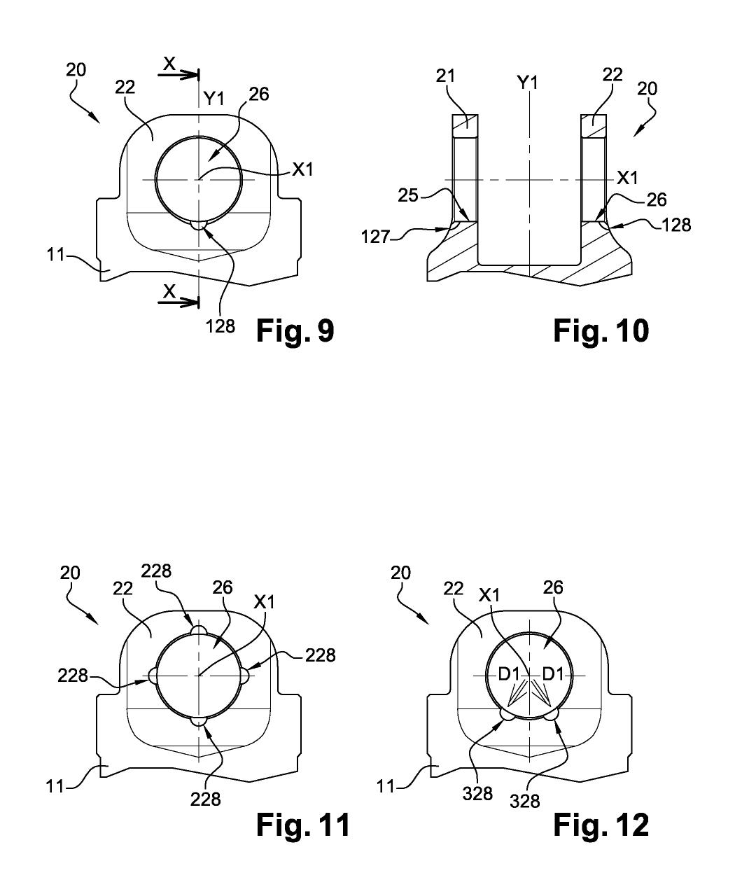

Others embodiments of the invention are represented on FIGS. 9 to 16. In these embodiments, elements similar to the first embodiment have the same references and work in the same way. Only the differences with respect to the first embodiment are described hereafter.

A second embodiment of the invention is represented on FIGS. 9 and 10. Each bore 25 and 26 is provided with a radial recess, respectively 127 and 128, which has a different shape in comparison with the first embodiment. Specifically, each recess 127 and 128 has a rounded concave shape in a transversal plane comprising both axes X1 and Y1. In other words, the radial recesses may have various shapes without leaving the scope of the invention.

A third embodiment of the invention is represented on FIG. 11. Only bore 26 is shown for simplification purpose, whereas bore 25 is similarly shaped. Bore 26 is provided with several radial recesses 228, which may have the shape of recess 28, recess 128 or any other shape adapted to the present application. Specifically, FIG. 11 shows four radial recesses 228 which are regularly distributed around axis X1 of bore 26. Thus, a greater material flow of pin 30 can penetrate into the plurality of recesses 228 during the caulking step.

A fourth embodiment of the invention is represented on FIG. 12. Only bore 26 is shown for simplification purpose, being understood that bore 25 is similarly shaped. Bore 26 is provided with two radial recesses 328, located towards the thickest portion 11 of the tappet 10. This embodiment provides a satisfying compromise between the amount of pin material that can be received in the recesses 328 and the mechanical resistance of flanges 21 and 22.

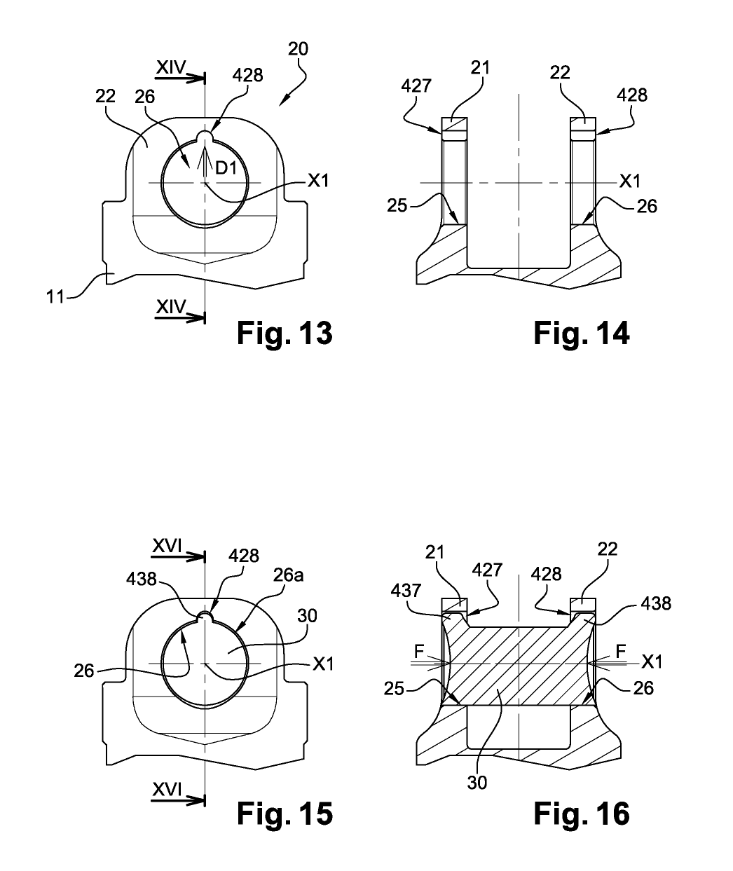

A fifth embodiment of the invention is represented on FIGS. 13 to 16. Each bore 25 and 26 is provided with a radial recess, respectively 427 and 428, which extends along the axis X1 through the full length of bore 25 or 26. A significant amount of pin material can be received in these recesses 427 and 428, providing a strong resistance pin 30 rotation around axis X1. Alternatively, recesses 427 and 428 can be located towards the thickest portion 11 of the tappet 10.

Other non-show embodiments can be implemented without leaving the scope of the invention. For example, radial recesses may have different shapes, positions and/or dimensions. According to another example, the support element 10 and/or the roller element 40 may have a different configuration depending on the intended application of the mechanical system 1.

Whatever the embodiment, at least one bore 25 and/or 26 of the mechanical system 1 comprises at least one radial recess 27, 28, 127, 128, 228, 328, 427 and/or 428, which extends from the bore along a radial direction relative to the axis X1 and is adapted to receive a radial portion of the caulked end 35 or 36 of the pin 30.

Moreover, the mechanical system 1 according to the invention is not limited to a cam follower as shown in particular on FIGS. 1 to 3. As an alternative example, the system 1 may constitute a rocker arm, wherein the support element 10 is not a tappet and wherein the roller element 40 is secured to an arm and a tappet, for example acting on a valve stem. Furthermore, the system 1 can comprise a sliding or rolling bearing, with bearing elements positioned between pin 30 and roller 40.

In addition, technical features of the different embodiments can be, in whole or part, combined with each other. For example, the bore 25 may comprise a recess 27, whereas the bore 26 may comprise a recess 428. Thus, the mechanical system 1 and its manufacturing method can be adapted to the specific requirements of the application.

A method for manufacturing a mechanical system, comprising a support element 10, a pin 30 and a roller element 40, includes the following step:
a) support element 10 is formed with two flanges 21-22 delimiting an intermediate gap 23;
b) two bores 25-26 extending along axis X1 are bored in the two flanges 21-22 of support element 10;
d) roller element 40 is positioned in intermediate gap 23 of support element 10, between both flanges 21-22 and both bores 25-26;
e) pin 30 comprising two opposite ends 35-36 is fitted in bores 25-26, roller element 40 being movable in rotation relative to pin 30 around axis X1;
f) opposite ends 35-36 of pin 30 are simultaneously caulked in the bores 25-26.

The method also comprises a step c), wherein at least one radial recess 27, 28, 127, 128, 228, 328, 427 and/or 428 is formed in at least one bore 25-26. Each radial recess extends from bore 25 or 26 along a particular radial direction relative to axis X1. Step c) is implemented after step a) and before step e), preferably between step b) and step d). In caulking step f), a radial portion 37, 38, 437 or 438) of caulked end 35-36 of pin 30 is plastically deformed and received in the or each radial recess delimited in the or each bore 25 or 26. This method can be especially implemented to manufacture a mechanical system 1 according to any one of the embodiments described above.

1. A mechanical system, comprising:
a support element including two bores extending along a first axis (X1),
a pin fitted into the two bores and having two opposite ends, each pin adapted to be caulked in one of the two bores, and
a roller element positioned between the two bores along the first axis (X1) and being movable in rotation relative to the pin around the first axis (X1), wherein
at least one bore including at least one radial recess extends from the bore along a radial direction (D1) relative to the first axis (X1) and is adapted to receive a plastically deformed radial portion of the caulked end of the pin.

2. The mechanical system according to claim 1, wherein each bore provides at least one radial recess.

3. The mechanical system according to claim 1, wherein the at least one radial recess is located towards the thickest portion of the support element.

4. The mechanical system according to claim 1, wherein the at least one radial recess extends along the first axis (X1) through the full length of its bore.

5. The mechanical system according to claim 1, wherein the at least one radial recess is delimited in the bore near an outer side, which is opposed to the roller element along the first axis (X1), of its bore.

6. The mechanical system according to claim 1, wherein the at least one radial recess has a triangular or rounded concave shape in a transversal plane comprising the first axis (X1).

7. The mechanical system according to claim 1, wherein the at least one of the two bores provides several radial recesses.

8. The mechanical system according to claim 7, wherein the radial recesses are regularly distributed around the first axis (X1) of the bore.

9. The mechanical system according to claim 1, wherein the pin is made of steel, with both pin ends being subjected to heat treatment before being caulked.

10. The mechanical system (1) according to claim 1, wherein the pin is made of bronze.

11. The mechanical system according to claim 1, further comprising a sliding or rolling bearing with bearing elements positioned between the pin and the roller element.

12. The mechanical system according to claim 1, further comprising a cam follower, wherein the support element is a tappet movable along a translation axis (Y1) perpendicular to the first axis (X1) and wherein the roller element is adapted to roll on an outer surface of a cam.

13. The mechanical system according to claim 1, further comprising a rocker arm, wherein the roller element is secured to an arm and a tappet, acting on a valve stem.

14. An injection pump for a diesel truck engine having a mechanical system, the mechanical system having;
a support element including two bores extending along a first axis (X1),
a pin fitted into the two bores and having two opposite ends, each pin adapted to be caulked in one of the two bores, and
a roller element positioned between the two bores along the first axis (X1) and being movable in rotation relative to the pin around the first axis (X1), wherein
at least one bore including at least one radial recess extends from the bore along a radial direction (D1) relative to the first axis (X1) and is adapted to receive a plastically deformed radial portion of the caulked end of the pin.

15. A method for manufacturing a mechanical system, the method including the following steps:
providing a support element, a pin and a roller element, and
forming the support element with two flanges that delimit an intermediate gap;
boring two bores that extend along a first axis (X1) in the two flanges of the support element;
positioning the roller element in the intermediate gap of the support element, between the two flanges and the two bores;
fitting the pin having two opposite ends in the two bores, the roller element being movable in rotation relative to the pin around the first axis (X1);
simultaneously caulking the two opposite ends of the pin in the two bores; and wherein
forming at least one radial recess in at least one bore, the radial recess extending from the bore along a radial direction (D1) relative to the first axis (X1),
plastically deforming a radial portion of the caulked ends of the pin and received in each radial recess delimited in each bore.
